(19) United States
(12) Patent Application Publication
(10) Pub. No.: US 2003/0095316 A1
(43) Pub. Date: May 22, 2003

(54) Method and installation for dertermining the physical properties of an object

(76) Inventors: Pascal Herbepin, Venissieux (FR); Jean Canetos, Lyon (FR); Jean-Louis Reynes, Decines (FR)

Correspondence Address: Ralph A Dowell, Dowell & Dowell, Suite 309, 1215 Jefferson David Highway, Arlington, VA, 22202, US

(21) Appl. No.: 10/169,507

(22) PCT Filed: Jan. 8, 2001
(86) PCT No.: PCT/FR01/00047

(30) Foreign Application Priority Data
Jan. 10, 2000 (FR) 00/00241

(51) Int. Cl. G02B 26/02

(52) U.S. Cl. 359/228

(57) ABSTRACT

The invention concerns a method whereby an optical signal representing the amount of ionizing light of at least a gas in the proximity of an object is displayed and/or recorded. Said method is characterized in that it consists in: gradually increasing (D₁) the voltage (U) between the object and the conductor element up to a final value (U₂) wherein the maximum brightness (L₁) is observed; determining, as first characteristic value of the object, the value of the voltage (U₂) as from which the brightness (L₂) is not less than about 10% of the maximum brightness (L₁) and in determining, as second characteristic value of the object, the voltage value as from which the brightness (L₃) of the signal is not less than about 90% of the maximum brightness (L₁). The installation comprises a sensor equipped with a flexible membrane defining a volume of confinement for a gas or a gas mixture wherein the ionization occurs.

The invention relates to a method and an installation for determining the physical properties of an object.

The physical properties of an object may be determined by studying phenomena of ionization on the surface or in the vicinity of this object when it is subjected to an electric potential different from a conductor element placed in the proximity.

Document FR-A-2 410 467 discloses using photography by Kirlian effect for the purpose of diagnosis on the human body. The variations in the composition of the photographic paper, in its humidity or in the composition of the developer baths are such that the results obtained by the Kirlian photograph on a photosensitive support are generally not reproducible. In addition, this known method involves working in a dark room and it is relatively long to carry out insofar as the results are visible only after development of the photosensitive supports.

Documents US-A-3 994 283 and DE-A-44 47 325 disclose devices for observing peripheral phenomena of ionization by Kirlian effect on the periphery of living organisms or of objects. These devices do not make it possible to characterize the studied objects with precision, insofar as the discharges observed present a random distribution in space and are not reproducible with satisfactory precision.

It is a more particular object of the invention to overcome these drawbacks by proposing a method and an installation which allow the determination, in real time or delayed time, of the physical properties of an object with an excellent reproducibility, with the result that systematic comparative studies can be envisaged.

In this spirit, the invention relates to a method for determining the physical properties of an object in the course of which:

this object is arranged in contact with a sensor of which a conductor element is electrically connected to a voltage generator;

an alternating voltage is applied between this object and this element;

an optical signal representative of the quantity of ionizing light of at least one gas in the vicinity of this object is displayed and/or recorded; characterized in that it consists in:

gradually increasing the afore-mentioned voltage up to a final value wherein the maximum brightness is observed;

determining, as first characteristic value of this object, the value of the voltage as from which the brightness is greater than or equal to about 10% of the maximum brightness and

determining, as second characteristic value of this object, the voltage value as from which the brightness of the signal is greater than or equal to about 90% of the maximum brightness.

The application of the voltage between the object and the conductor body may take place in differential mode or in common mode.

Thanks to the invention, the determination of the first and second characteristic voltage values makes it possible to characterize each object as these voltage values are representative of the behaviour of each object and their determination does not depend on the form and/or on the distribution of the ionization phenomena observed.

According to a first advantageous aspect of the invention, the voltage is increased in steps, each step corresponding to the acquisition of an image of the signal, for example by means of one or two synchronized cameras.

According to another advantageous aspect, the method also consists in determining, as other characteristic value of this object, an angle of phase-shift between the variation of brightness and the variation of voltage in time, this angle being defined as the difference in gradient between a first straight line representative of the increase in voltage in time and a second straight line representative of a linear evolution of the brightness in time between instants when the brightness has values respectively equal to about 10% and about 90% of the maximum brightness.

According to another advantageous aspect of the invention, the method consists in increasing the voltage by steps and in varying the frequency of this voltage at each step. This makes it possible to seek the energetic resonance of the object studied. In effect, an object may be modelized on the electrical plane as a network of circuits of RLC type in the form of a pseudo-anarchical organization. Each unitary network of RLC type presents its own resonance frequency and such a network reacts, i.e. oscillates, at certain frequencies, such a reaction determining the intrinsic electrical properties of the object. In other words, the frequency variation makes it possible, for each voltage value, to seek the resonance frequency at the voltage in question, the energetic resonance being marked by the appearance or the increase of the phenomena of ionization obtained. In addition, it may be provided to determine, as another characteristic value of the object, the frequency value which corresponds to a maximum relative brightness when the frequency varies, while the voltage is maintained at a value of step corresponding to an intermediate brightness, particularly equal to about 50% of the maximum brightness.

The method advantageously consists in dividing a surface of measurement defined around the object on the sensor into individual zones of measurement and in determining the afore-mentioned characteristic values for each individual zone of measurement. This aspect of the invention makes it possible to characterize the different edges of the object differently, each corresponding to an individualized zone or sector of measurement.

In the case of an application to the determination of the properties of a human or animal body, it is possible to apply the ten fingers of a subject simultaneously on at least one sensor and his/her ten toes on another sensor, to supply the conductor elements of these sensors in differential mode from the generator and to determine the afore-mentioned characteristic values concomitantly for the ten fingers and the ten toes. The concomitant nature of the determination of the characteristic values for the twenty tips avoids the application of a potential difference for the determination of first values, for example relative to a finger, modifying the electrical structure of the subject before the determination of other characteristic values.

The invention also relates to an installation for carrying out the method as defined hereinbefore and, more specifically, to an installation comprising a sensor presenting an electrically insulating plate and an electrically conducting element, means for electrically supplying the electrically conducting element and the object with a variable A.C. voltage and means for displaying and/or recording through the plate and the conductor element, an optical signal representative of the quantity of ionizing light in the vicinity of the object, due to the voltage applied. This installation is characterized in that the sensor comprises a flexible membrane defining, with the afore-mentioned plate, a volume of confinement of a gas or a gas mixture adapted to be ionized under the effect of the afore-mentioned voltage.

Thanks to the invention, the sensor makes it possible to monitor the exact nature of the gas which is ionized, since the composition of the confined gas or gas mixture may be predetermined, the voltage at which the ionization phenomena usually appear being able to be pre-established, as a function of the physical characteristics of the gases employed.

According to advantageous but non-obligatory aspects of the invention, the installation incorporates one or more of the following characteristics:

the flexible membrane is opaque, which makes it possible to use the sensor in daylight, the ionization being able to be displayed and/or recorded in a zone isolated from the ambient light by the opaque membrane.

the gas or gas mixture is imprisoned in a foam of deformable plastics material.

the installation comprises shape recognition means, means for quantifying the brightness of the signal observed, means for controlling the electrical supply means, means for automatically determining characteristic values of the object, means for comparison of these characteristic values with reference values and/or means for displaying the results of this determination or this comparison.

The invention will be more readily understood and other advantages thereof will appear more clearly in the light of the following description of two forms of embodiment of an installation in accordance with its principle and of the method for implementing it, given solely by way of example and made with reference to the accompanying drawings, in which:

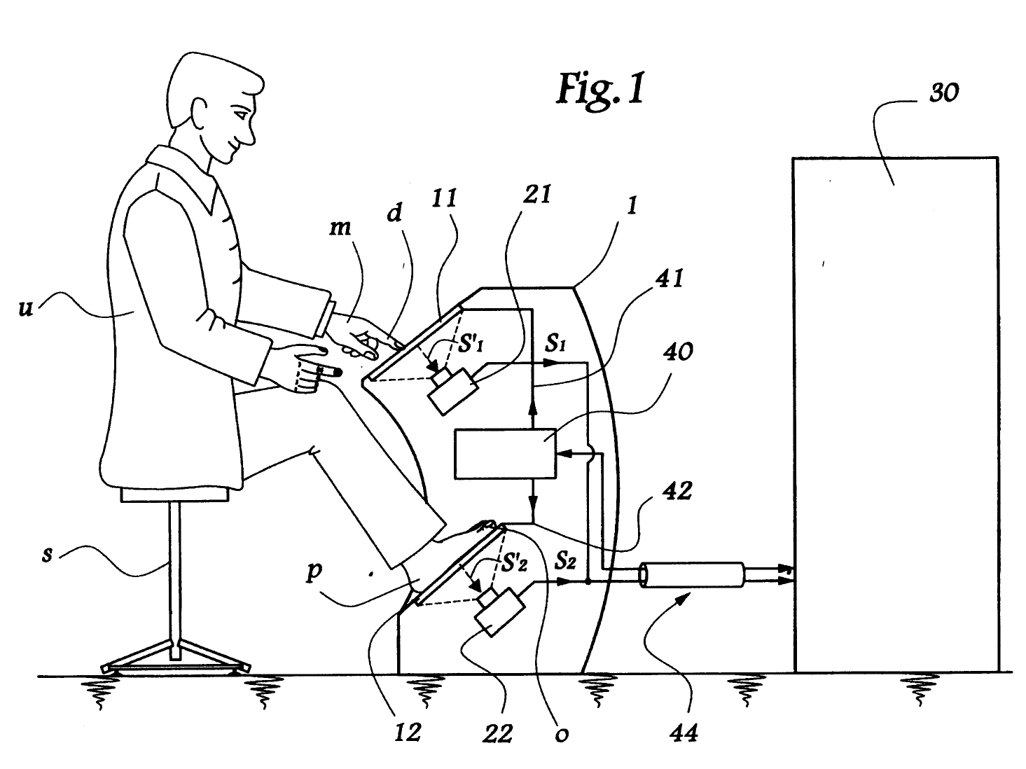

FIG. 1 schematically shows an installation according to the invention in the course of use.

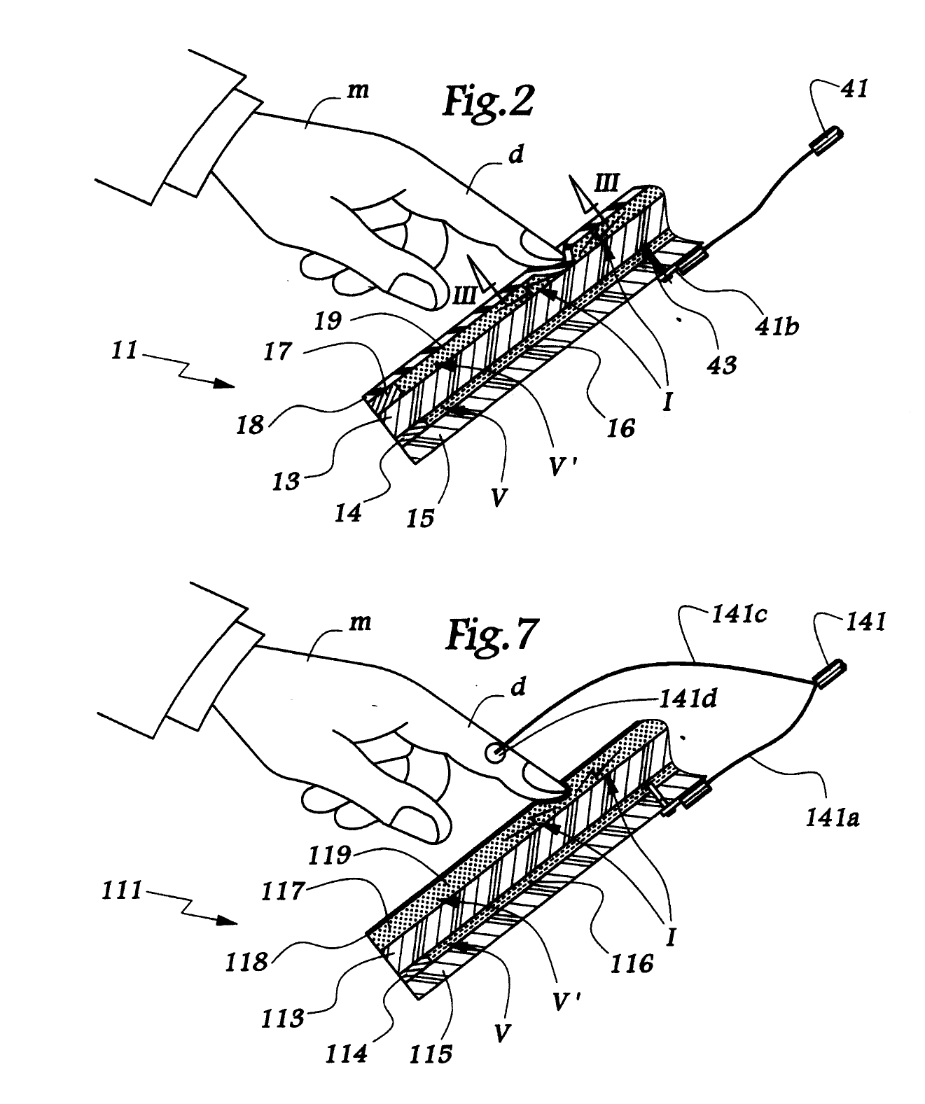

FIG. 2 is a partial section through a sensor used in the installation of FIG. 1.

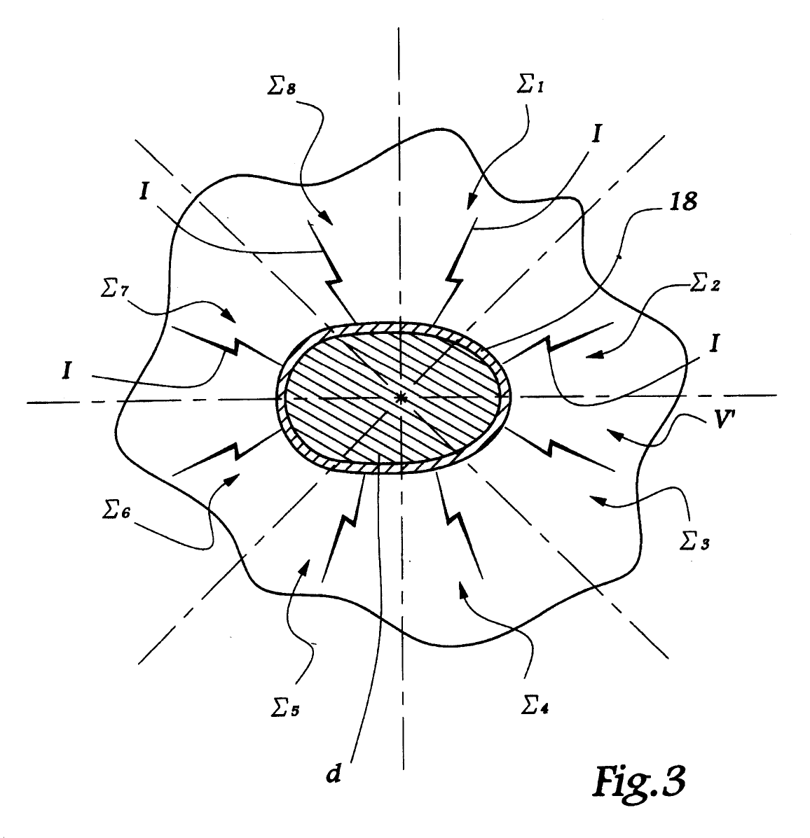

FIG. 3 is a partial section along line III-III in FIG. 2.

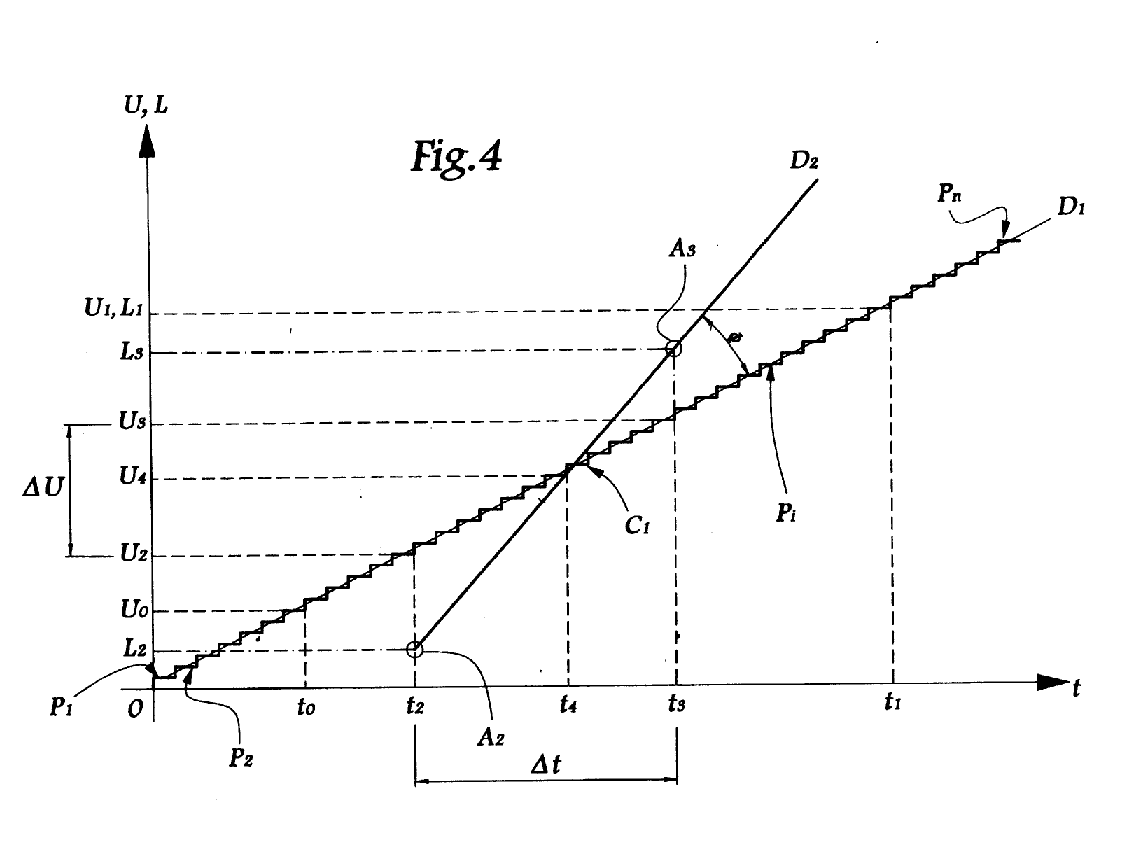

FIG. 4 is a representation of the variations in time of the voltage applied in the installation of FIGS. 1 to 3 and of the brightness.

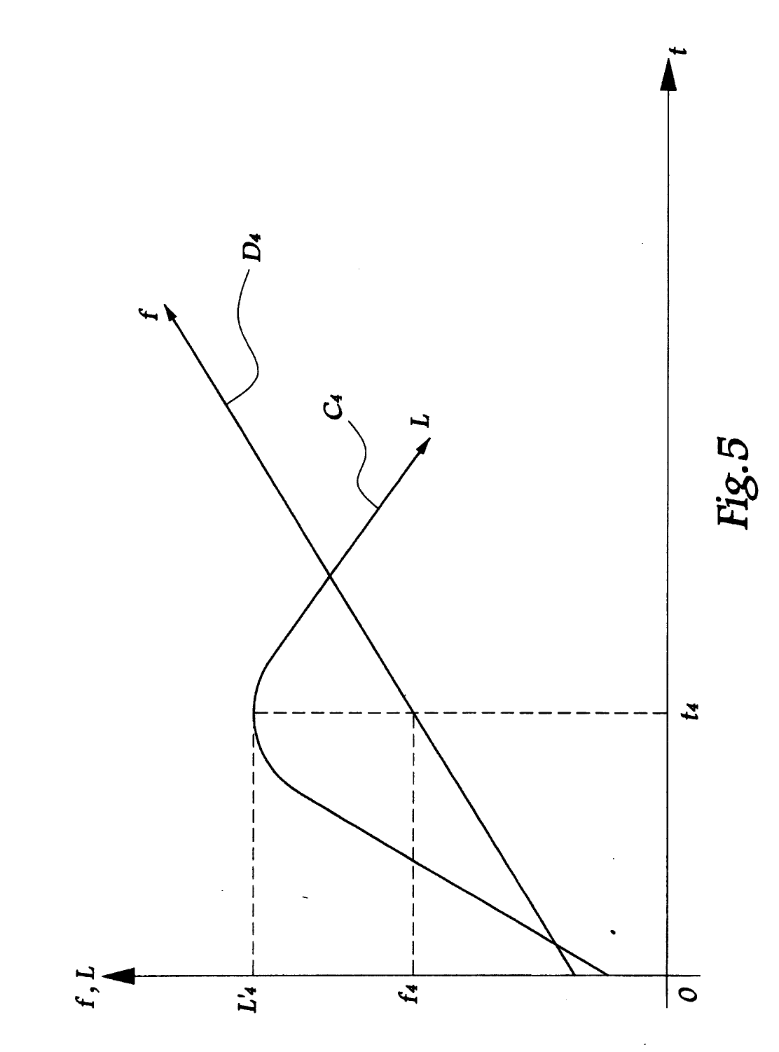

FIG. 5 is a representation of the variations of brightness during a step of the method of the invention.

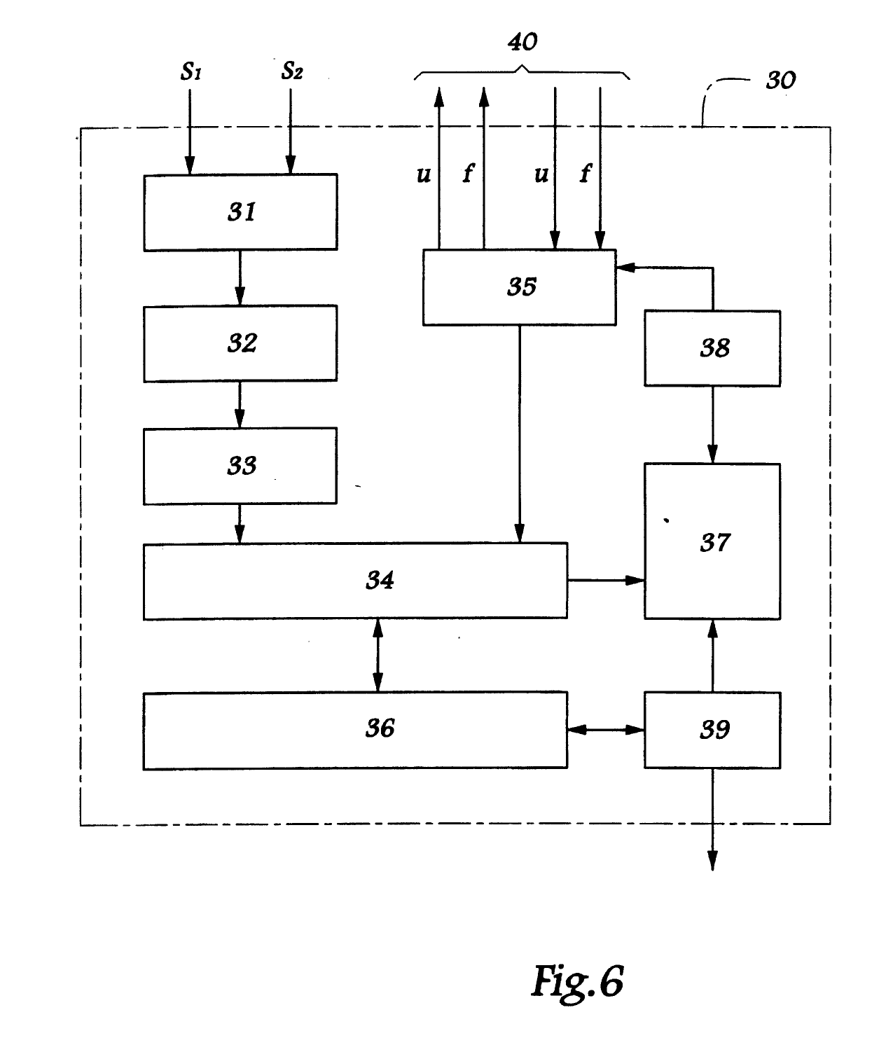

FIG. 6 is a logic block diagram of the optical signal processing part used in the installation of FIGS. 1 to 3.

FIG. 7 is a view similar to FIG. 2 for an installation according to a second form of embodiment of the invention.

The installation shown in FIGS. 1, 2, 3 and 6 comprises a casing I equipped with two sensors 11 and 12 arranged at the level of the envelope of the casing 1, with the result that a user U sitting on a seat S can place his/her hands on the sensor 11 and his/her feet on the sensor 12.

Two cameras 21 and 22 equipped with matrices of CCD type are respectively disposed to the rear of the sensors 11 and 12 with respect to the tips of the user's limbs. Each CCD matrix forms a network of photosensitive cells which generate a signal whose voltage is proportional to the brightness of that part of the signal S′₁ or S′₂ that they detect from the sensor 11 or 12. For example, in the case of a resolution with 8 bits, the output voltage of each cell varies linearly from 0 to 255 from black to white, which is currently called “brightness scale” in the computer or television domains. The brightness is sometimes symbolized in the video or computer systems by the variable Y. The camers 21 and 22 are adapted to furnish to a processing unit 30 video signals S₁ and S₂ representative of optical signals S′₁ and S′₂ that they detect, in particular of the brightness of these signals.

The sensors 11 and 12 are identical and the sensor 11, which is partially visible in FIG. 2, comprises an insulating plate 13 made for example of plastic material. A distance piece 14 makes it possible to define between the plate 13 and a second insulating plate 15 a volume V for receiving a liquid electrolyte 16, transparent or translucent, such as a gel of the type used in electro-cardiography or for echographies or a liquid soap. The plates 13 and 15 may be made of glass or plastics material of methyl polymethacrylate or polyacrylic type.

A second distance piece 17 is arranged on the edge of the plate 13 opposite the volume V and supports an opaque flexible membrane 18 made of a sheet of elastomer, such as rubber, synthetic or natural, or silicone. Between the plate 13 and the membrane 18 there is defined a volume V′ for receiving a gas mixture 19 including argon, neon and carbon dioxide. These gases present the noteworthy property of giving rise to phenomena of ionization I of different colours, namely blue for argon, orange for neon and green for carbon dioxide, these phenomena of ionization occurring at different and predetermined ionization potentials. These phenomena of ionization are obtained by displacement of electrical charges under the effect of the difference in potential between the object, i.e. for example the finger or fingers and the electrolyte 16 such displacements of charges giving rise to photons. These phenomena of ionization are produced at voltage values lower than the threshold values for priming or discharge of the gases in question, with the result that the system of the invention does not induce the creation of potentially dangerous electric arcs or discharges.

A variable A.C. voltage generator 40 is connected to the electrolytes 16 of the sensors 11 and 12 by electrical linkages 41, 42 respectively. The linkages 41 and 42 make it possible to apply between these electrolytes 16 and through the user's body a variable A.C. voltage U of which f denotes the frequency. In this way, taking into account the impedance of the user's body, a voltage difference is created, by this differential mode, on the one hand, between the fingers d of the user and the electrolyte 16 of the sensor 11 and, on the other hand, between his/her feet p or toes o and the electrolyte 16 of the sensor 12. The conductor forming the line 41 is connected to a lug 41b in abutment against the surface of the plate 15 opposite the volume V and maintained in position by a metal screw 43 which passes right through the plate 15, with the result that it is in electrical contact with the electrolyte 16.

In practice, the user can place his/her two hands m on the sensor 11 and his/her two feet p on the sensor 12, twenty potential ionization zones being monitored, which correspond respectively to the positions of the tips of the user's fingers and toes.

As the membrane 18 is flexible, the pressure exerted by the user's finger d makes it possible to deform this membrane, to the point of driving out the gas mixture located between the membrane 18 and the plate 13 at the level of the finger. The gas mixture is thus distributed around the finger and is capable of being ionized when the voltage difference U is included in a predetermined range which depends on the nature of the mixture 19. In this way, the volume of gas or of gas mixture 19 used in the sensor 11 is not very great, which is significant from the economical standpoint and concerning the user's and operator's safety.

The opaque nature of the membrane 18 enables the cameras 21 and 22 to efficiently detect the phenomena of ionization I as soon as they appear, as they occur in the visible spectrum, while the cameras are isolated from the outside light by the casing 1 and the membrane 18.

Operation is as follows:

From the initial instant 0, the voltage U is progressively increased by steps P₁, P₂. . . Pᵢ . . . P_{N}, as represented by line C, in FIG. 4. The central points of the different steps of this line may be joined by a straight line D₁ which may be considered as an approximation of line C_{1.}

The rise in voltage along the line C₁, is synchronized with the speed of acquisition of cameras 21 and 22. For example, in the case of video cameras operating at 25 images/second, the duration of each step Pᵢ is 40 ms, a step P₁ thus being displayed thanks to two picture frames on each signal S₁ or S₂.

From an instant at which the voltage U has a value U₀, the camera 21 or 22 associated with the sensor in question detects the appearance of light issuing from ionization and the brightness L of the optical signal S′₁ or S′₂ becomes non-zero. The brightness is defined as the light intensity of the signal S′₁ or S′₂ observed.

When the voltage U continues to increase, the brightness of the signal S′₁ or S′₂ increases as the phenomena of ionization I are more and more numerous.

The voltage U thus increases up to a value U from which a maximum brightness L₁ is obtained. t₁ denotes the instant when the voltage U attains value U₁.

Two values L₂ and L₃ are then determined, respectively equal to 10% and to 90% of the value L₁. On the basis of the data recorded by the unit 30 from the signals S₁ and S₂, the voltages U₂ and U₃, for which the brightness is respectively equal to L₂ and L₃, are determined. These values U₂ and U₃ are values characteristic of the finger d in question as, in practice, they prove to be determined in reproducible manner for the same finger and under identical operational conditions.

On the basis of the recordings of signals S₁ or S₂, it is possible to determine the instants t₀, t₁, t₂ and t₃ at which the values U₀ to U₃ of the voltage U were respectively attained. ΔU denotes the difference between the values of U₂ and U₃. The gradient of the straight line D₁ is equal to ΔU/Δt.

It is possible to establish, on a figure of the type of FIG. 4, and after having plotted the voltage and brightness scales on the y-axis, a line representative of the evolution of the brightness, by joining points A₂ and A₃ defined as the points where the brightness is respectively equal to L₂ or L₃ at instants t₂ or t₃. These points represent the evolution of the brightness from value L₂ to value L₃ over an interval of time Δt. D₂ denotes a straight line passing through points A₂ and A₃ of which the gradient is equal to (L₃−L₂)/Δt.

Φ denotes the angle of phase shift of gradient between the straight lines D₁ and D₂. This angle may be considered as an energetic index characteristic of the object studied, in the present case the finger d of the user.

At each voltage step P₁ of the line C₁, the frequency f of the voltage U is modulated by the generator 40 in a frequency range included between about 1000 Hz and about 800 kHz.

In this way, for each voltage U applied, the different frequencies capable of causing the equivalent electrical circuit of the object studied to resonate are successively tested. This test is rapid as it takes place for the duration of each step Pᵢ which may be of the order of 40 ms as indicated hereinabove.

As is seen in FIG. 5, although the frequency f evolves regularly in the course of time as represented by the straight line D₄, the brightness observed evolves in variable manner as represented by line C₄.

A brightness value L₄ is defined equal to about 50% of the value L₁ and U₄ denotes the corresponding voltage value obtained at the same instant t₄ as the brightness L₄. On the corresponding voltage step, the frequency f of the voltage U₄ delivered by the generator 40 is continuously varied and the variation of the brightness as represented by the line C₄ is observed. The brightness increases progressively until it reaches, at an instant t₄, a maximum relative value L′₄ for the voltage U₄; the brightness then decreases. The frequency f₄ corresponding to the maximum value L′₄ is then noted and this frequency f₄ is defined as the energetic frequency of the object studied, i.e. the frequency at which a maximum relative brightness L′₄ is obtained, which may be assimilated to an electromagnetic resonance frequency.

It is also possible to determine the energetic frequency for several intermediate voltage levels between the values U₀ and U₁.

As is more particularly visible in FIG. 3, that part of the volume V′ surrounding the tip of the finger d is divided into angular sectors Σ₁ to Σ₈ in each of which are produced phenomena of ionization I and in each of which the characteristic values U₂, U₃, θ and f₄ may be determined as indicated hereinabove. In effect, as a function of the orientation of the finger d and of the positioning of the nerve ends, it is possible that the phenomena of ionization occur in these sectors at distinct instants and for different voltages. Of course, the number and definition of the sectors Σ₁ to Σ₈ depend on the choices made during modelization.

The unit 30 is schematically shown in FIG. 6 and comprises a first module 31 for acquisition of the video signals S₁ and S₂, a second module 32 for recognition of shapes making it possible to locate the zone of abutment of each finger d on the sensor 11 or of each toe o on the sensor 12 and to define the sectors Σ₁ to Σ₈. A module 33 for quantifying the brightness per zone makes it possible to analyze the signals S₁ and S₂ coming from the module 32, the corresponding signals in that case being transmitted to a calculator 34 adapted to effect the logic operations previously envisaged for determining the characteristic values U₂, U₃, Φ and f₄. The calculator 34 is connected to an interface 35 which is connected to the generator 40 and makes it possible to control it and know, permanently, the values of the voltage and frequency generated.

The computer 34 is also connected to a data base 36 in which are stored reference values of the characteristic magnitudes for known objects, which allows a comparison between the magnitudes determined during each experiment and these known objects.

A monitor 37 is also provided to inform the user of the result of the operations effected by the calculator 34, this monitor making it possible to monitor a module 38 for controlling the interface 35.

Finally, a device 39 allows access to an internal or external data processing network for the confrontation of data and/or access to these additional reference data.

The unit 30 assembly may be integrated in a computer incorporated in the casing 1 or connected thereto by a suitable linkage 44.

When the signals S₁ and S₂ corresponding to the different sectors Σ₁ to Σ₈ have been processed, preferably simultaneously, for each finger d or toes of the user, the final step of the method consists in attaching the characteristic values detected U₂, U₃, Φ and f₄, to each sector Σ₁ to Σ₈, to allow a quantitative and qualitative analysis.

In the second form of embodiment of the invention shown in FIG. 6, elements similar to those of the first embodiment bear identical references increased by 100. The sensor 111 of this embodiment comprises two insulating plates 113 and 115 separated by a distance piece 114 and defining therebetween a volume V for receiving a liquid electrolyte which may be connected by a conductor 141a of a linkage 141 to a generator (not shown) of the type of generator 40. A second conductor 141c connects the opposite terminal of the generator and the finger d of the user, which makes it possible to apply a predetermined voltage directly between this finger and the electrolyte 116. In that case, the generator functions in common mode and the measurement may be limited to one finger d only, without need for the user to place his/her feet on the sensor 12.

The conductor 141c may be placed in contact with the finger d thanks to a conducting pellet 141c of the type used in electro-cardiography.

According to a variant, the potential issuing from the generator may be applied by the conductor 141c to the wrist of the user, the latter being able to apply the five fingers of his/her hand on the sensor 111.

On the side of the plate 113 opposite the volume V there is arranged a layer 117 of foam of transparent plastics material, for example based on polymer, comprising micro-cells in which a gas or a gas mixture 119 of the type of mixture 19 is imprisoned. An opaque coating 118 is arranged on the layer 117 and insulates this layer from the ambient atmosphere, imprisoning the gas or mixture 119. The coating 118 is flexible and therefore constitutes a membrane defining the volume V′ of the layer 117 in which the mixture 119 is confined.

As previously, a user can deform the coating 118 and the layer 117 when he/she presses the tip of a finger d, which has the effect of driving the gas mixture around this finger.

As previously, the phenomena of ionization I may be displayed by transparency through the plates 113 and 115 and the electrolyte 116, which are transparent like the plates 13 and 15 and the electrolyte 16.

The sensor of the first embodiment may be used with a voltage supply in common mode, while the sensor 111 may be used with a voltage supply device in differential mode, this resulting from a choice of the operator.

Whatever the form of embodiment in question, the electrolyte 16 or 116 constitutes a first armature of a capacitor of which the second armature is constituted by the object to be studied, for example the finger d or the toe of a user.

The present invention may be used for the characterization of biological bodies and, in particular, the determination of the biological properties of a human, animal or vegetable body. It may be used by a practitioner for determining meridians in the sense of acupuncture, the flowpath of an energy fluid, such as the blood of a mammal or the sap of a plant, this latter application of the invention making it possible to monitor the biological characteristics of the plants with a view to selection thereof.

In particular, the invention makes it possible to compare the characteristics of plants with one another, for example the biological characteristics of plants obtained by crops of different biological, intensive or transgenic types.

Another particularly important application of the invention concerns the monitoring of dimensions, structure or of the state of mechanical or electrical parts, insofar as more concentrated zones of electric discharges may be observed on a piece presenting micro-cracks, lines of weakness or surface defects.

The invention may also be used in the domain of hydrology, for example for an analytic approach of the composition of water, and in the field of fundamental research, particularly for the differentiation of cells of similar structure.

1. Method for determining the physical properties of an object (m, p, d) in the course of which:
said object is arranged in contact with a sensor (11, 12; 111) of which a conductor element (16, 116) is electrically connected to a voltage generator (40);
an alternating voltage (U) is applied between said object and said element;
an optical signal (S′₁, S′₂) representative of the quantity of ionizing light (L) of at least one gas (19, 119) in the vicinity of said object is displayed and/or recorded;
characterized in that it consists in:
gradually increasing said voltage (U) up to a final value (U₁) wherein a maximum brightness (L₁) is observed;
determining, as first characteristic value of said object, the value of said voltage (U₂) as from which the brightness (L₂) of the signal is greater than or equal to about 10% of the maximum brightness and
determining, as second characteristic value of said object, the value of said voltage (U₃) as from which the brightness (L₃) of the signal is greater than or equal to about 90% of the maximum brightness.

2. Method according to claim 1, characterized in that it consists in increasing said voltage in steps (Pᵢ), each step corresponding to the acquisition of an image of said signal (S′₁, S′₂).

3. Method according to one of the preceding claims, characterized in that it consists in determining, as other characteristic value of said object (m, p, d), an angle of phase shift (Φ) between the variation of brightness (L₁-L₃) and the variation of voltage (U₀-U₃) in time, said angle being defined as the difference in gradient between a first straight line (D₁) representative of the increase in voltage (U) in time and a second straight line representative of a linear evolution of the brightness in time, between instants (A₂, A₃) where the brightness has values (L₂, L₃) respectively equal to about 10% and about 90% of the maximum brightness (L₁).

4. Method according to one of the preceding claims, characterized in that it consists in increasing said voltage (U) in steps (P₁) and in varying the frequency (f) of said voltage on each step.

5. Method according to claim 4, characterized in that it consists in determining, as other characteristic value of said object, the value of the frequency (f₄) of said voltage (U) corresponding to a maximum relative brightness (L′₄) when said frequency (f) varies, while said voltage is maintained at a step value (U₄) corresponding to an intermediate brightness (L₄) particularly equal to about 50% of the maximum brightness (L₁).

6. Method according to one of the preceding claims, characterized in that it consists in dividing a surface of measurement defined around said object (d) on said sensor (11) into individual zones of measurement (Σ₁-Σ₈) and in determining said characteristic values (U₂, U₃, Φ, f₄) for each individual zone of measurement.

7. Method according to one of the preceding claims, characterized in that it consists in measuring the physical properties of a human or animal body by simultaneously applying the ten fingers (d) of a subject on at least one sensor (11) and the ten toes (O) of said subject on at least one other sensor (12), in supplying the conductor elements (16) of these sensors in differential mode from a voltage generator (40) and in determining said characteristic values in parallel for the ten fingers and the ten toes.

8. Installation intended for carrying out a method according to one of the preceding claims for determining the physical properties of an object (m, p, d), said installation comprising:
a sensor (11, 12, 111) comprising an electrically insulating plate (13, 113) and an electrically conducting element (16, 116),
means (40) for electrically supplying said electrically conducting element and said object with a variable A.C. voltage (U) and
means (21, 22, 30) for displaying and/or recording through said plate and said conductor element, an optical signal (S₁, S₂) representative of the quantity of light (L) for ionization of said object, due to said voltage applied,
characterized in that said sensor comprises a flexible membrane (18, 118) defining, with said plate (13, 113), a volume (V′) for confinement of a gas or a gas mixture (19, 119) adapted to be ionized under the effect of said voltage (U),
in that said sensor is connected to a generator (40) so as to create a voltage (V) between said object (m, p, d) and said conductor element (16, 116), and
in that there are provided means (30) for processing said optical signal (S₁, S₂) and for controlling said generator, arranged for carrying out a method according to one of the preceding claims.

9. Installation according to claim 8, characterized in that said flexible membrane (18, 118) is opaque.

10. Installation according to one of claims 8 or 9, characterized in that said gas or gas mixture (119) is imprisoned in a foam of deformable plastics material (117).

11. Installation according to one of claims 8 to 10, characterized in that it comprises shape recognition means (32), means (33) for quantifying the brightness of the signal observed (S′₁, S′₂), means (38) for controlling said electrical supply means (40), means (34) for automatically determining characteristic values (U₂, U₃, Φ, f₄) of said object (m, p, d), means (36) for comparison with reference values and/or means (37) for displaying the results of the determination or of the comparison.
